(19) United States
(12) Patent Application Publication
(10) Pub. No.: US 2014/0184802 A1
(43) Pub. Date: Jul. 3, 2014

(54) TECHNIQUES FOR REDUCING CONSUMER WAIT TIME

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/729,728

(22) Filed: Dec. 28, 2012

(51) Int. Cl. H04N 7/18

(52) U.S. Cl. CPC H04N 7/181
USPC 348/159

(57) ABSTRACT

A computer-implemented method is disclosed herein. The method includes the step of monitoring a plurality of locations within a retail store with respective cameras directed at each location and generating respective monitoring video signals. The method also includes the step of receiving, at a processing device of a commerce server, an access signal from a head mountable unit worn by a consumer in the retail store containing a request for access to at least one of the monitoring video signals. The method also includes the step of transmitting, with the processing device, at least one of the monitoring video signals to the head mountable unit in response to said receiving step.

### BACKGROUND INFORMATION

1. Field of the Disclosure

The present invention relates generally to helping minimize the time a consumer must spend waiting in line at a retail store. In particular, examples of the present invention are related to techniques for allowing a consumer to receive video feeds showing various locations within the retail store. The consumer can thus be informed of the location having the least wait time.

2. Background

Retail stores can extend across thousands of square feet and offer many thousands of distinct products in a plurality of different departments. The flow of consumers out of and within a retail store can bottleneck at various locations. For example, in some departments of a retail store, a consumer can receive individualized attention, such as a deli, a pharmacy, and a customer service counter. Lines of consumers can form at these locations. Check-out stations can also become locations at which lines of consumers form. A consumer can become displeased when perceiving excessive wait times in a retail store. When this occurs, it is possible that a consumer will stop shopping in order to shop at another retail store or are less likely to return.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating a head mountable unit that can be applied in some embodiments of the present disclosure.

FIG. 3 is an example block diagram illustration a commerce server that can be applied in some embodiments of the present disclosure.

FIG. 4A is an example screen shot of the display visible with the head mountable unit during shopping in some embodiments of the present disclosure.

FIG. 4B is another example screen shot of the display visible with the head mountable unit during shopping in some embodiments of the present disclosure.

FIG. 4C is another example screen shot of the display visible with the head mountable unit during shopping in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist a consumer in identifying locations within a retail store having relatively low traffic. This will allow the consumer to visit locations in the store that will require the least amount of wait time. In other words, embodiments of the present disclosure can help a consumer find areas of relatively fast moving or non-blocking traffic. The consumer's shopping experience will thereby be enhanced. A system according to some embodiments of the disclosure can include a commerce server receiving signals from an electronic device such as a head mountable unit worn by the consumer. The commerce server can also access video feeds, or “monitoring video signals,” generated within the retail store. The head mountable unit can transmit one or more signals as the consumer shops in the retail store. The one or more signals can indicate that the consumer desires to access the monitoring video signals in order to minimize the time the consumer will spend waiting in lines at the retail store.

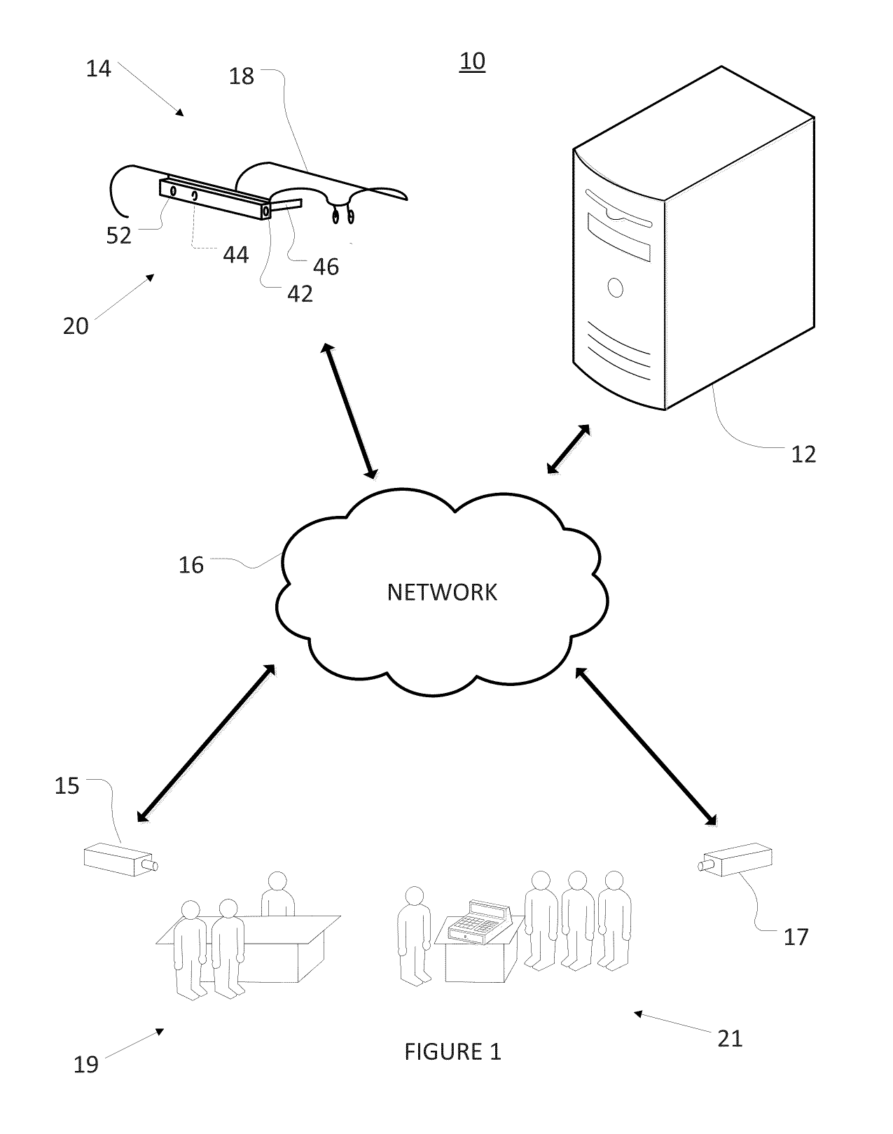

To illustrate, FIG. 1 is a schematic illustrating a monitoring system 10 according to some embodiments of the present disclosure. The monitoring system 10 can implement a computer-implemented method that includes the step monitoring, with a commerce server 12, a plurality of locations within a retail store with respective cameras 15, 17 directed at each location. For example, a location such as a pharmacy counter 19 and a checkout station 21 can be monitored. Any location in a retail store at which a line of consumers often forms can be monitored by a camera.

The commerce server can also 12 receive an access signal from a head mountable unit 14 worn by a consumer in the retail store. The access signal can contain a request for access to at least one of the monitoring video signals generated by the cameras 15, 17. The head mountable unit 14 can be worn by a consumer while moving within the retail store. In the illustrated embodiment of FIG. 1, the exemplary head mountable unit 14 includes a frame 18 and a communications unit 20 supported on the frame 18.

The access signal transmitted by the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

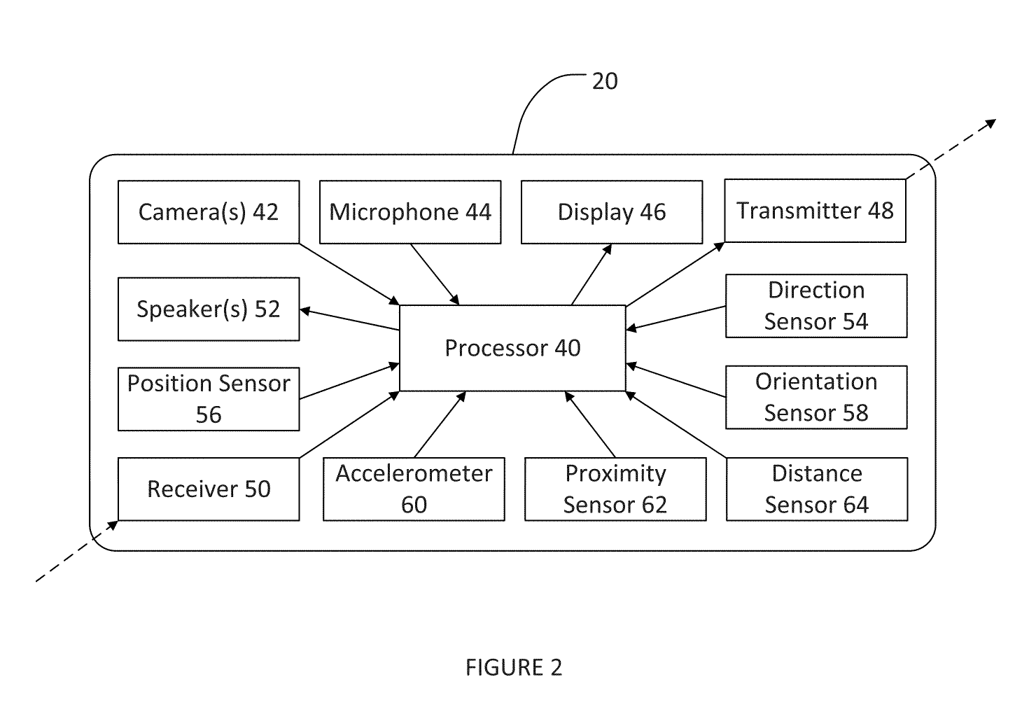

FIG. 2 is a block diagram illustrating exemplary components of the communications unit 20. The communications unit can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the consumer wearing the head mountable unit 14. Each camera 42 can be operable to capture single images and/or video and to generate a video signal based thereon. The video signal may be representative of the field of view of the consumer wearing the head mountable unit 14.

In some embodiments of the disclosure, cameras 42 may be a plurality of forward-facing cameras 42. The cameras 42 can be a stereo camera with two or more lenses with a separate image sensor or film frame for each lens. This arrangement allows the camera to simulate human binocular vision and thus capture three-dimensional images. This process is known as stereo photography. The cameras 42 can be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the consumer is spaced from the object. Determining the distance that the consumer is spaced from the object can be executed by the processor 40 or by the commerce server 12 using known distance calculation techniques.

Processing of the one or more, forward-facing video signals can also be applied to determine the identity of the object. Determining the identity of the object, such as the identity of a product in the retail store, can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can cropped to an area of interest to reduce the transmission of data to the commerce server 12.

In some embodiments of the present disclosure, the cameras 42 can include one or more inwardly-facing camera 42 directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the object the consumer is viewing.

The camera 42 can also be configured to generate a consumer video signal that corresponds to the field of view of the consumer wearing the head mountable unit 14. The consumer video signal can be processed to assist in determining if the consumer desires access to the monitoring video signals. An access signal can be contained in the consumer video signal. For example, a consumer can make a hand gesture in the field of view of the camera that can be interpreted by the commerce server 12 as a request for access to a monitoring video signal generated by one of the cameras.

The microphone 44 can be configured to generate an audio signal that corresponds to sound generated by and/or proximate to the consumer. The audio signal can be processed by the processor 40 or by the commerce server 12. For example, verbal signals can be processed by the commerce server 12 such as “this product appears interesting.” Such audio signals can be correlated to the video recording.

The audio signal received through the microphone 44 can be processed in some embodiments of the present disclosure to detect a request for access to the monitoring video signals. For example, verbal signals can be processed by the commerce server 12 such as “please show me the line at the deli counter.” This verbal signal defines a request for accessing a particular monitoring video signal. In some embodiments of the present disclosure, a consumer can state “where is the shortest checkout line?” This verbal signal defines criteria for the commerce server 12 to select a monitoring video signal from among a plurality of monitoring video signals.

The display 46 can be positioned within the consumer's field of view. Video content can be shown to the consumer with the display 46. The display 46 can be configured to display text, graphics, images, illustrations and any other video signals to the consumer. The display 46 can be transparent when not in use and partially transparent when in use to minimize the obstruction of the consumer's field of view through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 40 and the transmitter 48 is operable to transmit the video signal and/or audio signal from the head mountable unit 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the consumer. The speaker 52 can be positioned within the consumer's range of hearing. Audio content transmitted by the commerce server 12 can be played for the consumer through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the consumer is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 16. By way of example and not limitation, the direction signal can be useful in determining the identity of a product(s) visible in the video signal, as well as the location of the consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the consumer within the retail store. The position sensor 56 can be configured to detect an absolute or relative position of the consumer wearing the head mountable unit 14. The position sensor 56 can electrically communicate a position signal containing position data to the processor 40 and the processor 40 can control the transmitter 48 to transmit the position signal to the commerce server 12 through the network 16.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the consumer and are visible in the video signal.

The position sensor 56 configured to generate a position signal indicative of the position of the consumer within the retail store. The position signal can be processed by the commerce server 12 to identify a location that is proximate to the consumer and is experiencing relatively low traffic. For example, the consumer can request access to a monitoring video signal of the shortest checkout line. If two checkout lines are equally short but one is closer to the consumer than the other, the commerce server 12 can apply the consumer's position to select the checkout line that is closer to the consumer.

The orientation sensor 58 can be configured to generate an orientation signal indicative of the orientation of the consumer's head, such as the extent to which the consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the consumer's head can indicate whether the consumer is viewing a lower shelf, an upper shelf, or a middle shelf.

The accelerometer 60 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 60 can be a sensor that is operable to detect the motion of the consumer wearing the head mountable unit 14. The accelerometer 60 can generate a signal based on the movement that is detected and communicate the signal to the processor 40. The motion that is detected can be the acceleration of the consumer and the processor 40 can derive the velocity of the consumer from the acceleration. Alternatively, the commerce server 12 can process the acceleration signal to derive the velocity and acceleration of the consumer in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a consumer has grasped and is inspecting a product. In addition, in some embodiments, a consumer can execute a physical gesture near the proximity sensor 62 to initiate some action or function, such as video processing.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the consumer is facing. The distance signal can be useful in determining the distance to an object in the video signal generated by one of the cameras 42, which can be useful in determining the consumer's location in the retail store.

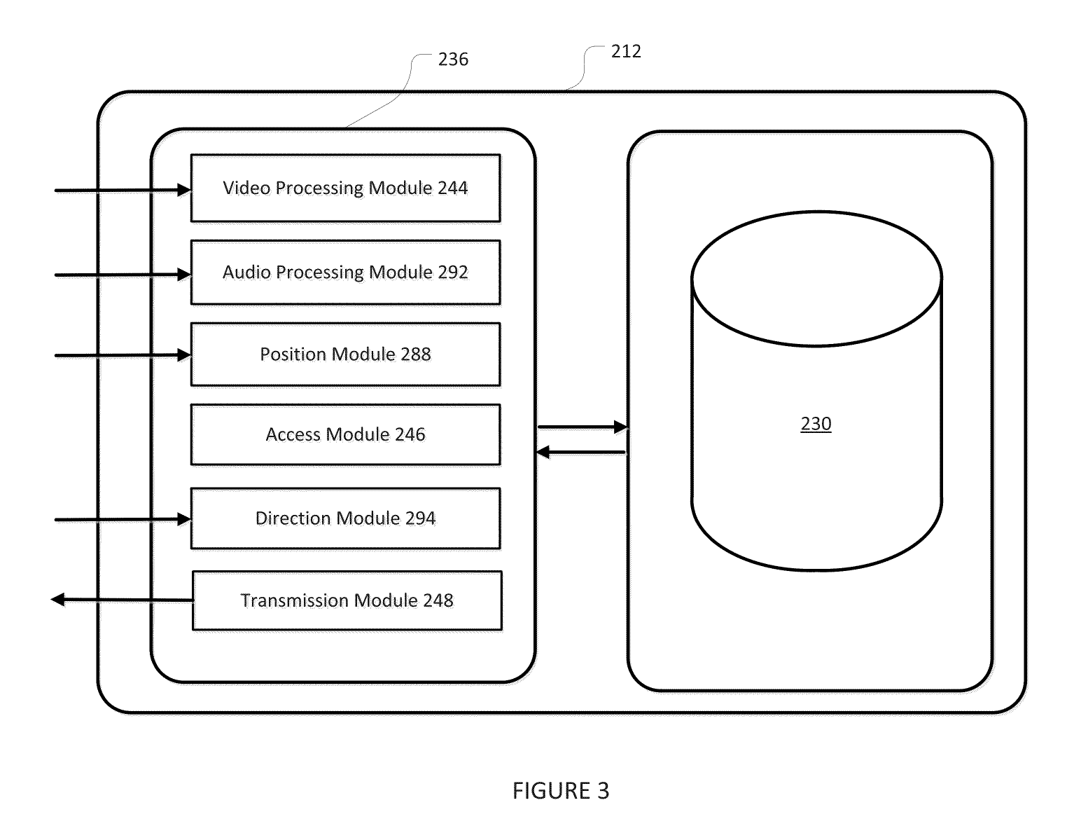

FIG. 3 is a block diagram illustrating a commerce server 212 according to some embodiments of the present disclosure. In the illustrated embodiment, the commerce server 212 can include a store monitoring database 230. The commerce server 212 can also include a processing device 236 configured to include a video processing module 244, an access module 246, a transmission module 248, a position module 288, an audio processing module 292, and a direction module 294.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The store monitoring database 230 can include memory containing the floor plan of the retail store, including each location monitored by a camera. The database 230 can correlate each of the locations with one of the video monitoring signals. The data in the store monitoring database 230 can be organized based on one or more tables that may utilize one or more algorithms and/or indexes.

The processing device 236 can communicate with the store monitoring database 230 and receive one or more signals from the head mountable unit 14. The processing device 236 can include computer readable memory storing computer readable instructions and one or more processors executing the computer readable instructions.

The processing device 236 can be operable to receive the one or more signals from the head mountable unit 14 that contain an access signal, an indication that the consumer desires access to one of the monitoring video signals. In some embodiments, the access signal can be contained in a video signal from the camera 42 of the head mountable unit 14. The video processing module 244 can analyze the video signal received from the head mountable unit 14. The video processing module 244 can analyze the video signal for any indication that access to a monitoring video signal is desired.

The video processing module 244 can implement known video recognition/analysis techniques and algorithms to identify the access signal. For example, in some embodiments, the consumer's hand making a swiping motion or rotating or pointing can be detected by the video processing module 244 and be recognized as an access signal.

In some embodiments, the access signal can be contained in an audio signal collected by the microphone 44 of the head mountable unit 14. The audio processing module 292 can analyze the audio signal received from the head mountable unit 14. The audio processing module 292 can analyze the audio signal for any indication that access to a monitoring video signal is desired.

The audio processing module 292 can implement known speech recognition techniques to identify speech in the audio signal, such as a voice message indicating that the consumer desires access to a monitoring video signal. For example, in some embodiments, the consumer can state “please show me the customer service counter,” “show me all of the checkout lines,” or “show me the shortest checkout line.” By way of example and not limitation, such statements can be processed by the audio processing module 292 and recognized as an access signal. The microphone 44 of the head mountable unit 14 can receive the verbal sounds spoken by the consumer.

The processing device 236 can also include a transmission module 248 operable to transmit a monitoring video signal to the head mountable unit 14 in response to an access signal transmitted to the commerce serve 12 from the head mountable unit.

The processing device 236 can also include an access module 246 operable to correlate an access signal with one of the monitoring video signals. The access module 246 can correlate an access signal containing a request for a specific monitoring video signal. For example, if the consumer requests the monitoring video signal of the first checkout line, the access module 246 can first function cooperatively with the audio processing module 292 to recognize that the consumer has indicated a specific monitoring video signal to access. The access module 246 can then access the store monitoring database 230 and identify the monitoring video signal that correspond to the first checkout line. The access module 246 can then direct the monitoring video signal of the first checkout line to the transmission module 248 for transmission to the head mountable unit 14.

The access module 246 can also correlate an access signal containing selection criteria with data derived or contained in various components of the commerce server 12. For example, if the consumer requests the monitoring video signal of the shortest checkout line, the access module 246 can first function cooperatively with the audio processing module 292 to recognize that the consumer has provided criteria for selecting one of the monitoring video signals. The access module 246 can then access the store monitoring database 230 and identify the monitoring video signals that correspond to checkout lines. The access module 246 can next function cooperatively with the video processing module 244. Applying the criteria “shortest” derived by the audio processing module 292, the access module 246 can direct the video processing module 244 to analyze the monitoring video signals being received from locations indicated in the store monitoring database 230 as being associated with checkout lines. The video processing module 244 can implement known video recognition/analysis techniques and algorithms to determine the number of consumers visible in each of the relevant monitoring video signals. The access module 246 can then direct the monitoring video signal in which the fewest consumers are visible to the transmission module 248 for transmission to the head mountable unit 14.

In some embodiments, the processing device 236 can also include a position module 288. The position module 288 can be operable to function cooperatively with the access module 246 to identify a monitoring video signal corresponding to a location in the retail store. The position module 288 can receive the position signal from the head mountable unit 14. The position signal can be generated by the indoor position sensor 42 and contain data corresponding to a location of the head mountable unit 14 in the retail store. The position of the consumer can be a factor applied in selecting a monitoring video signal to be transmitted to the consumer. For example, if the consumer communicates criteria for selecting one of the monitoring video signals, such as the shortest line, the position of the consumer can be applied to select one of two locations having the same number of consumers in line.

In some embodiments, the processing device 236 can also include a direction module 294. The direction module 294 can be operable to function cooperatively with the access module 246 to assist the consumer in reaching the location corresponding to the monitoring video signal that is transmitted to the head mountable unit 14. For example, the direction module 294 can receive the consumer direction signal from the head mountable unit 14. The consumer direction signal can be generated by the direction sensor 54 and contain data corresponding to a direction of the head mountable unit 14 in the retail store. The access module 246 can correlate the direction of the consumer with the location of the monitoring video signal and can direct the transmission module 248 to transmit a location direction signal. The location direction signal can be displayed on the display 46 of the head mountable unit 14.

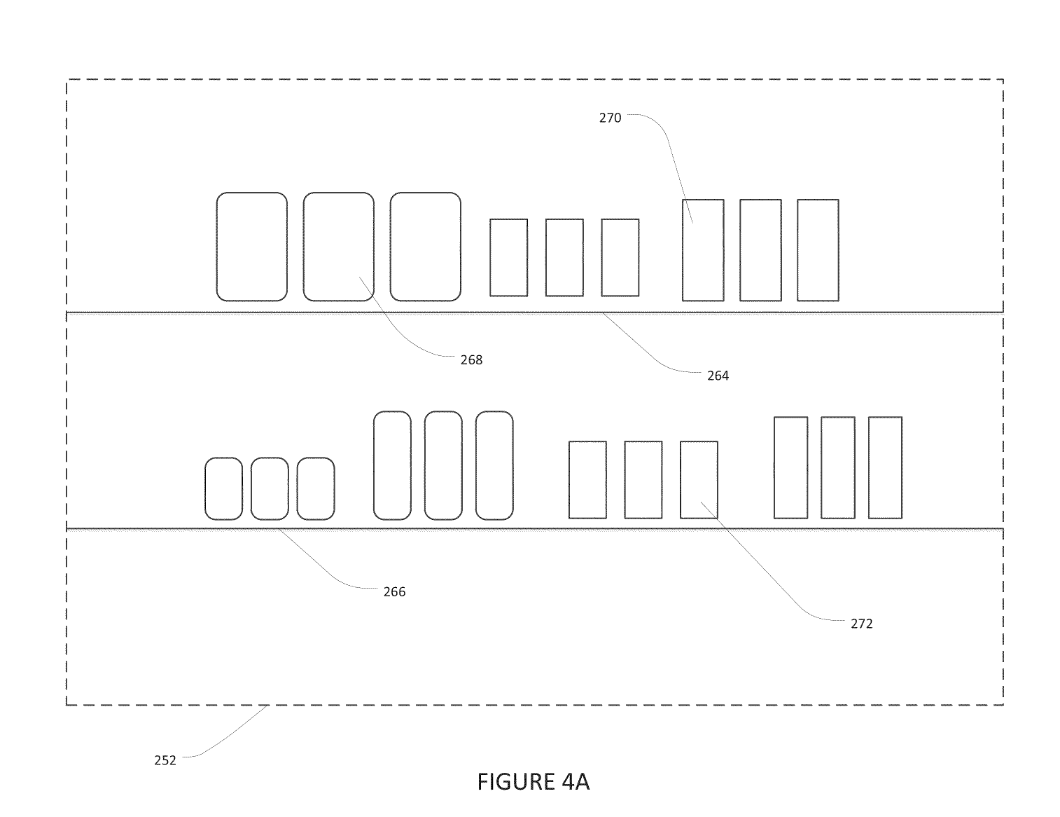

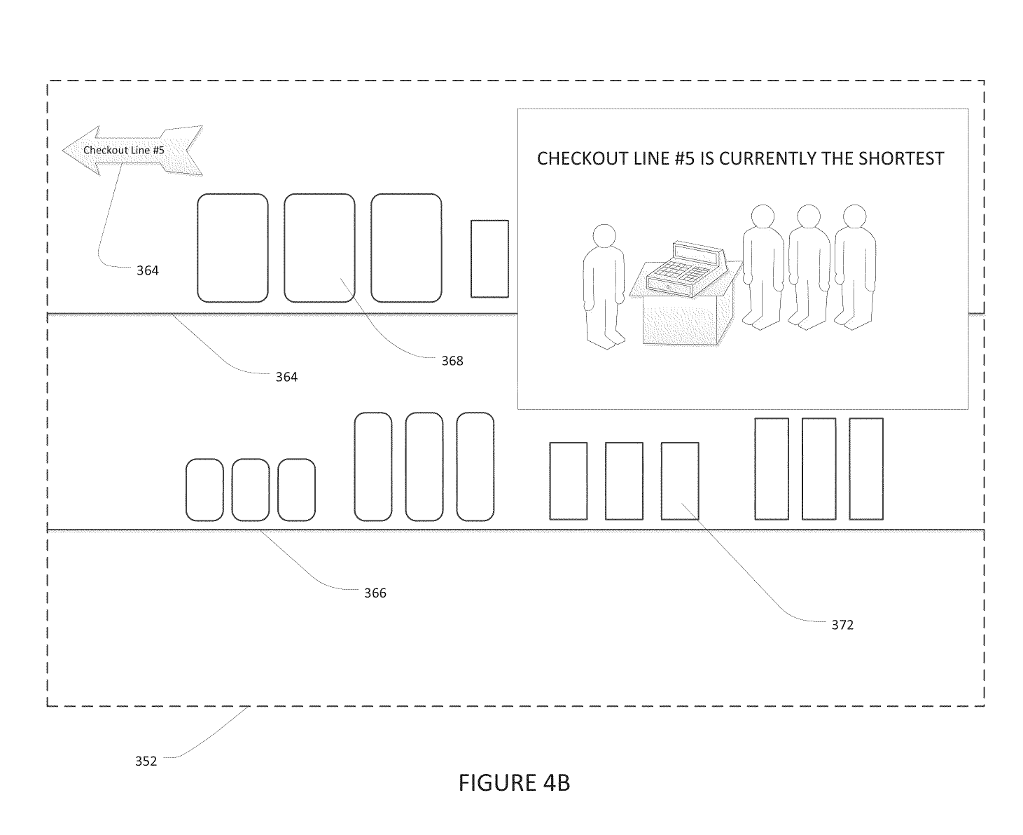

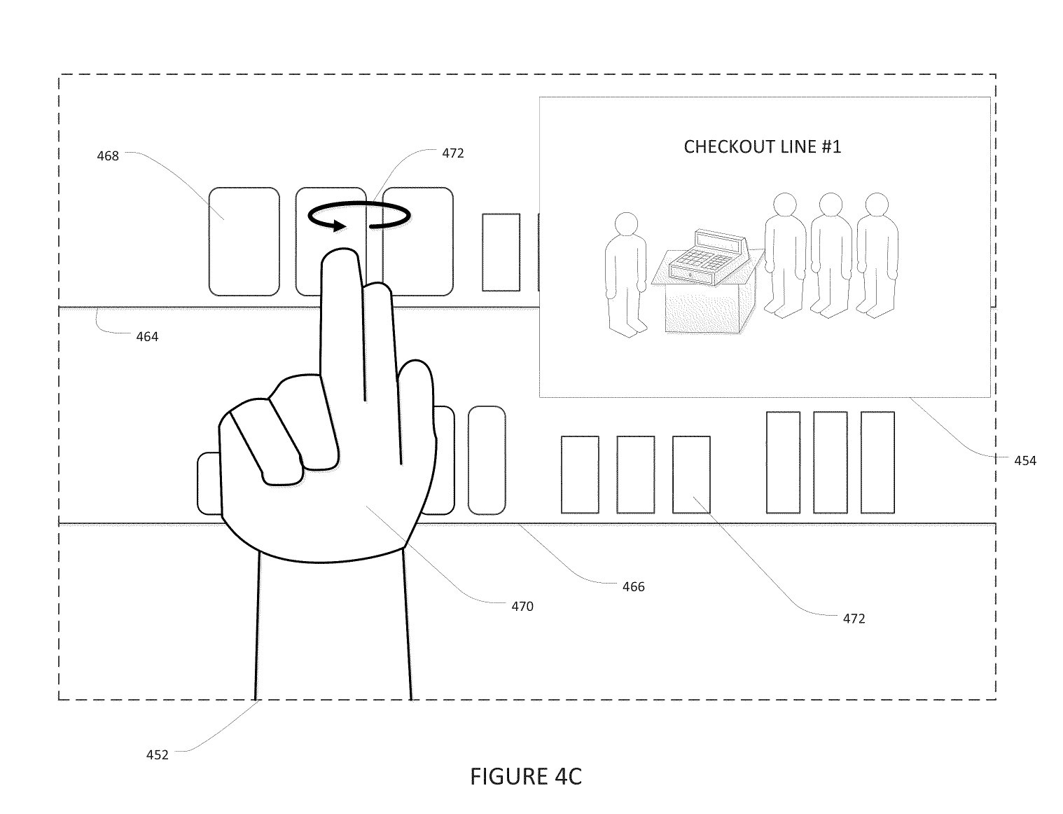

FIGS. 4A-4D illustrate views that can be perceived by the consumer and by the video processing module 244 in some embodiments of the present disclosure. The camera 42 and display 46 of the head mountable unit 14 can be generally aligned such that the display 46 overlaps the field of view of the camera 42. In other words, the camera 42 is arranged so that the video signal received by the commerce server 212 is substantially similar to the field of view through the display 46 for the consumer wearing the head mountable unit 14.

FIG. 4A is an exemplary screen shot of a field of view that can be visible to the consumer and also received as a video signal by the video processing module 244. The screen shot can fill the display 252 or can be a portion of the display 252. The consumer can be looking through at least part of the display 252 and viewing products, such as products 268, 270, 272, supported on shelves 264, 266 prior to generating an access signal. FIG. 4A is an exemplary field of view prior to the transmission of a monitoring video signal from the commerce server 212.

FIG. 4B is an exemplary screen shot of a field of view that can be visible to the consumer and also received as a video signal by the video processing module 244. The screen shot can fill the display 352 or can be a portion of the display 352. The consumer can be looking through at least part of the display 352 and viewing products, such as products 368 and 372, supported on shelves 364, 366.

FIG. 4B is an exemplary screen shot of the display 352 after the consumer has request to be shown the shortest checkout line. When a location is selected by the consumer, a camera in the retail store can be rotated if necessary to provide a better view of the location. The access module 246 determined which checkout line was the shortest and the transmission module 248 has transmitted the live monitoring video signal of the shortest checkout line for viewing on the display 352. The monitoring video signal can be displayed in a portion 354 of the display 352.

FIG. 4B also shows an exemplary and optional feature of providing a location direction signal to the consumer. In FIG. 4B, the transmission module 248 has transmitted a location direction signal to the head mountable unit 14. The location direction signal has been processed by the processor 26 of the communications unit 20, resulting in a visual indicia in the form of an arrow 358 visible in the display 352.

FIG. 4C is a screen shot of a field of view that can be visible to the consumer and also received as a video signal by the video processing module 244. The screen shot can fill the display 452 or can be a portion of the display 452. The consumer can be looking through at least part of the display 452 and viewing products, such as products 468 and 472, supported on shelves 464, 466.

FIG. 4C illustrates an exemplary embodiment of the invention in which a consumer video signal transmitted to the commerce server 12 can contain an access signal. In FIG. 4C, the consumer has verbally requested to access the monitoring video signal for checkout line number one. The monitoring video signal for checkout line number one is displayed in a portion 454 of the display 452. The consumer can then toggle to view other checkout lines by presenting his/her hand 470 in the field of view of the camera and execute a scrolling motion, such as represented by arrow 472. This motion of the hand 470 can be interpreted by the processing device 236 as an access signal, a request to access other monitoring video signals. In response to the motion represented by arrow 472, the monitoring video signal for checkout line number one can be replaced with the monitoring video signal for checkout line number two.

It is noted that the various processing functions set forth above can be executed differently than described above in order to enhance the efficiency of an embodiment of the present disclosure in a particular operating environment. The processor 40 can assume a greater role in processing some of the signals in some embodiments of the invention. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the consumer. For example, the processor 40 could receive all of the monitoring video signals and can be configured to select one of the monitoring video signals to display to the consumer with the display 46 in response to data contained the plurality of monitoring video signals.

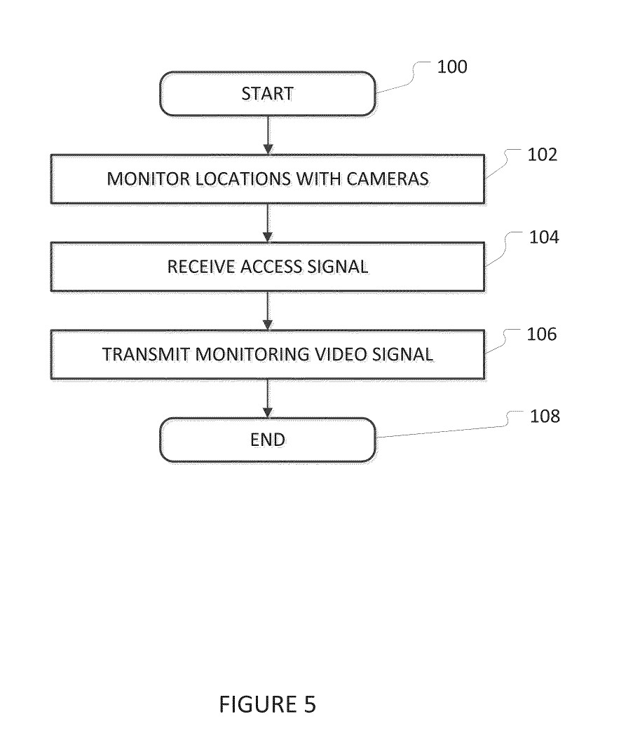

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 is a flow chart illustrating a method that can be carried out in some embodiments of the present disclosure. The method can be executed by a commerce server. The commerce server can be located at the retail store or can be remote from the retail store. The method starts at step 100. At step 102, the commerce server can monitor a plurality of locations within the retail store with respective cameras directed at each location. Each camera can generate a respective monitoring video signals associated with one of the locations.

At step 104, the commerce server can receive an access signal from a head mountable unit worn by a consumer in the retail store. The access signal can contain a request for access to at least one of the monitoring video signals. A consumer can desire to access one of the monitoring video signals to determine locations without heavy or slow moving traffic in order to avoid long lines.

At step 106, the commerce server can transmit one of the monitoring video signals to the head mountable unit in response to the receiving step. The monitoring video signal can be presented to the consumer on a display of the head mountable unit. The exemplary method ends at step 108.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
monitoring, with a processing device of a commerce server, a plurality of locations within a retail store with respective cameras directed at each location and generating respective monitoring video signals;
receiving, at the processing device, an access signal from a head mountable unit worn by a consumer in the retail store containing a request for access to at least one of the monitoring video signals; and
transmitting, with the processing device, at least one of the monitoring video signals to the head mountable unit in response to said receiving step.

2. The computer-implemented method of claim 1 wherein said receiving step further comprises:
receiving, at the processing device of the commerce server, an audio signal as the access signal.

3. The computer-implemented method of claim 1 wherein said receiving step further comprises:
receiving, at the processing device of the commerce server, a video signal from the head mountable unit as the access signal.

4. The computer-implemented method of claim 1 wherein said receiving step further comprises:
receiving, at the processing device of the commerce server, an access signal from the head mountable unit worn by the consumer in the retail store containing a request for access to a particular monitoring video signal from among the plurality of monitoring video signals.

5. The computer-implemented method of claim 1 wherein said receiving step further comprises:
receiving, at the processing device of the commerce server, an access signal from the head mountable unit worn by the consumer in the retail store containing criteria for selecting one monitoring video signal from among the plurality of monitoring video signals.

6. The computer-implemented method of claim 5 further comprising:
determining, with the processing device of the commerce server, one monitoring video signal from among the plurality of monitoring video signals matching the criteria in the signal received from the head mountable unit to transmit in said transmitting step.

7. The computer-implemented method of claim 6 wherein said determining step further comprises:
analyzing, with the processing device of the commerce server, all of the monitoring video signals received from the cameras to determine the one monitoring video signal to transmit in said transmitting step.

8. The computer-implemented method of claim 7 wherein said analyzing step further comprises:
identifying, with the processing device of the commerce server, a number of people visible in each of the monitoring video signals received from the cameras.

9. The computer-implemented method of claim 5 further comprising:
receiving, at a processing device of a commerce server, a position signal from the head mountable unit; and
determining, with the processing device of the commerce server, the monitoring video signal corresponding to the location closest to the head mountable unit to transmit in said transmitting step.

10. The computer-implemented method of claim 5 wherein said transmitting step further comprises:
determining, with the processing device of the commerce server, a first monitoring video signal from among the plurality of monitoring video signals matching the criteria in the signal received from the head mountable unit;
transmitting, with the processing device, the first monitoring video signal to the head mountable unit in response to said receiving step;
reassessing, with the processing device, the plurality of monitoring video signals in response to the criteria after said step of transmitting the first monitoring video signal; and
transmitting, with the processing device, a second monitoring video signal different than the first monitoring video signal to the head mountable unit in response to said reassessing step.

11. The computer-implemented method of claim 1 further comprising:
transmitting, with the processing device, a location direction signal to the head mountable unit configured for visual display by a display of the head mountable unit.

12. A commerce server comprising:
a processing device operable to receive monitoring video signals from a plurality of video cameras in a retail store and an access signal from a head mountable unit worn by a consumer in the retail store and including:
a video processing module operable to monitoring a plurality of locations within a retail store with respective cameras directed at each location and generating respective monitoring video signals;
an access module operable to receive an access signal from a head mountable unit worn by a consumer in the retail store containing a request for access to at least one of the monitoring video signals; and
a transmission module operable to transmit at least one of the monitoring video signals to the head mountable unit in response to receipt of the access signal.

13. The commerce server of claim 12 wherein said processing device further comprises:
an audio processing module operable to process audio signals and detect commands and data conveyed by voice.

14. The commerce server of claim 12 wherein said processing device further comprises:
a position module operable to process a position signal and detect a location of the head mountable unit within the retail store.

15. The commerce server of claim 12 wherein said processing device further comprises:
a direction module operable to process a direction signal and detect direction of the head mountable unit within the retail store.

16. The commerce server of claim 12 wherein said commerce server further comprises:
a location database containing and correlating the locations in the retail store monitored by the cameras with the monitoring video signals.

17. A computer-implemented method comprising:
providing a retail store containing a plurality of products;
communicating with a consumer shopping in the retail store through an electronic device possessed by the consumer with a processing device of a commerce server;
monitoring a plurality of locations within a retail store with respective cameras directed at each location and generating respective monitoring video signals;
receiving, at the processing device, an access signal from the electronic device containing a request for access to at least one of the monitoring video signals; and
transmitting, with the processing device, at least one of the monitoring video signals to the electronic device in response to said receiving step.

18. The computer-implemented method of claim 17 further comprising:
selecting, with the processing device, the at least one monitoring video signal to transmit in response to data contained in more than one of the plurality of monitoring video signals.

19. The computer-implemented method of claim 17 further comprising:
receiving, with the processing device, an audio signal from the electronic device; and
selecting, with the processing device, the at least one monitoring video signal to transmit in response to data contained in more than one of the plurality of monitoring video signals and in response to the audio signal.

20. The computer-implemented method of claim 17 further comprising:
receiving, with the processing device, a position signal from the electronic device; and
selecting, with the processing device, the at least one monitoring video signal to transmit in response to data contained in more than one of the plurality of monitoring video signals and in response to the position signal.

21. The computer-implemented method of claim 17 wherein said transmitting step further comprises:
transmitting, with the processing device, all of the monitoring video signals to the electronic device in response to said receiving step.

22. The computer-implemented method of claim 21 further comprising:
selecting, with the electronic device, one of the monitoring video signals to display to the consumer in response to data contained in more than one of the plurality of monitoring video signals.
